(19) United States
(12) Patent Application Publication
(10) Pub. No.: US 2020/0001627 A1
(43) Pub. Date: Jan. 2, 2020

(54) SENSOR DEVICE AND IMAGE FORMING APPARATUS

(71) Applicant: CANON KABUSHIKI KAISHA, Tokyo (JP)

(72) Inventor: Takahiro Suzuki, Ichikawa-shi (JP)

(21) Appl. No.: 16/452,807

(22) Filed: Jun. 26, 2019

(30) Foreign Application Priority Data
Jul. 2, 2018 (JP) 2018-126365

(51) Int. Cl. B41J 11/00; G03G 15/00

(52) U.S. Cl. CPC B41J 11/0095; G03G 15/607; G03G 2215/00746; G03G 2215/00721; G03G 15/70

(57) ABSTRACT

Provided is a sensor control apparatus including a main board and a plurality of sensors to the main board. The main board alternately applies a first voltage and a second voltage to the plurality of sensors, to thereby cause the plurality of sensors to perform detection operations in order from an upstream side. A time period for applying the first voltage to a sensor that is not a target from which a detection result is to be acquired is shorter than a time period for applying the first voltage to a sensor that is the target from which a detection result is to be acquired.

### BACKGROUND OF THE INVENTION

### Field of the Invention

The present disclosure relates to a technology for controlling a sensor configured to detect a sheet when the sheet is being conveyed in a copying machine, a printer, or other such image forming apparatus.

### Description of the Related Art

In an image forming apparatus and an auto document feeder (ADF), a large number of sensors are arranged in order to control internal devices. For example, the image forming apparatus is mounted with a large number of sensors including a sensor to be used for detecting presence or absence of a sheet, a sensor to be used for detecting a conveying position of the sheet, and a sensor to be used for detecting opening or closing of an exterior cover of the apparatus. The image forming apparatus or other such apparatus operates the internal devices based on detection results of the sensors, to thereby perform, for example, sheet conveyance control. To that end, a large number of sensors arranged at various positions in the apparatus and a controller configured to acquire the detection results of the sensors and perform control are connected to one another through a cable. As the number of sensors increase, the number of cables to be used inside the image forming apparatus or other such apparatus also increases. As the number of cables increases, the wiring space and the number of connectors on the controller increase. The increases in the number of cables and number of connectors hinder downsizing of the entire apparatus, and cause an increase in cost.

Therefore, there is proposed a technology for reducing the number of cables and the number of connectors by connecting a plurality of sensors in series to the controller (see Japanese Patent Application Laid-Open No. 2008-59161). In Japanese Patent Application Laid-Open No. 2008-59161, sensors each including a light emitting diode (LED) and a phototransistor are used. Each of the sensors can detect the presence or absence of a sheet and the opening or closing of the exterior cover based on whether or not a shielding object is provided between the LED and the phototransistor. The sensors each include a resistor having a different resistance value. For example, the detection result obtained when the sheet is detected by one of the sensors is represented by a voltage value different from that of any other one of the sensors depending on the resistance value. Therefore, it is possible to discriminate which sensor the detection result has been obtained from.

When a plurality of sensors including resistors having mutually different resistance values are connected in series, an order in which the sensors are connected in series is determined based on the resistance values. When a connection order of sensors is mistaken, detection results obtained by the respective sensors are mixed up. Outer shapes of the respective sensors can also be made unique based on the resistance values so as to avoid causing a mistake in correspondences between the resistance values of the sensors and places thereof in the connection order. However, in this case, the sensors increase in kind (resistance value and outer shape), to thereby cause a problem of, for example, an increase in management cost due to a higher cost of components and more complicated component management.

This problem is solved by connecting a plurality of sensors of the same kind (of the same outer shape and having the same internal circuit) in series to allow the detection results to be independently acquired from the respective sensors. As such a solution method, there is a method in which a function of cutting off power to a sensor on a downstream side is provided in each of the sensors to supply power to the sensors one by one in order from the sensor on an upstream side while simultaneously performing detection. In this method, the number of sensors being supplied with power to perform detection is one at all times, which allows the controller to determine the states of the respective sensors when it is possible to grasp which place in the connection order the sensor being supplied with power is.

A sensor for identifying the position of the sheet being conveyed is required to perform detection with a short cycle period. However, a plurality of sensors connected in series are different from each other in cycle period for performing the detection depending on a detection target. In the above-mentioned method, all the plurality of sensors connected in series perform detection operations sequentially, and then start the subsequent detection operations. Therefore, when there coexist sensors having different detection cycle periods, a sensor configured to perform detection with a long cycle period performs the detection more frequently than required. As a result, in proportion to the number of connected sensors, one round of the detection operations performed by all the sensors takes more time than required. For this reason, the controller configured to control the operations of the respective sensors wastes resources for performing other processing. The present disclosure has an object to operate each sensor with its unique detection cycle period even with a configuration in which a plurality of sensors of the same kind are connected in series.

### SUMMARY OF THE INVENTION

A sensor device according to the present disclosure includes: a plurality of sensors connected in series, wherein the plurality of sensors include a first sensor and a second sensor connected to the first sensor, and wherein each of the plurality of sensors includes: a first switch provided to a first power supply line for receiving a voltage; a second switch provided to a second power supply line for supplying the voltage to another sensor that is subsequently connected among the plurality of sensors; and a contact provided between the first power supply line and the second power supply line, wherein the contact is positioned at an upstream side of the first switch; a voltage supply circuit configured to supply the voltage, wherein the voltage supply circuit is connected to the first sensor among the plurality of sensors; and wherein a state of the first switch becomes a conductive state in a case where a first voltage is received when states of the first switch and the second switch are a cutoff state; wherein the state of the first switch becomes the cutoff state in a case where a second voltage different from the first voltage is received when (i) the state of the first switch is the conductive state and (ii) the state of the second switch is the cutoff state; wherein the state of the second switch becomes a conductive state in a case where the second voltage is received when the states of the first switch and the second switch are the cutoff state; wherein the states of the first switch and the second switch become the cutoff state in a case where the voltage supply circuit is controlled to a predetermined condition; wherein the voltage supply circuit executes first processing in which the first voltage is supplied during a first time period, and second processing in which the first voltage is supplied during a second time period, which is shorter than the first time period.

Further features of the present invention will become apparent from the following description of exemplary embodiments (with reference to the attached drawings).

### BRIEF DESCRIPTION OF THE DRAWINGS

FIG. 1 is a configuration diagram of an image forming apparatus according to at least one embodiment of the present disclosure.

FIG. 2 is a configuration diagram of a main board and sensors.

FIG. 3 is a flow chart for illustrating operation control processing.

FIG. 4 is a timing chart exhibited when operations are controlled.

FIG. 5 is an explanatory diagram of a power supply voltage exhibited when detection processing is to be skipped.

FIG. 6 is an explanatory diagram of a power supply voltage exhibited when there coexist sensors having different detection cycle periods.

FIG. 7 is a configuration diagram of a main board and sensors.

FIG. 8 is a flow chart for illustrating operation control processing.

FIG. 9 is a timing chart exhibited when operations are controlled.

FIG. 10 is a timing chart exhibited when operations are controlled.

FIG. 11 is an explanatory diagram of a power supply voltage exhibited when the detection processing is to be skipped.

FIG. 12 is an explanatory diagram of a power supply voltage exhibited when there coexist sensors having different detection cycle periods.

### DESCRIPTION OF THE EMBODIMENTS

Now, embodiments of the present disclosure are described in detail with reference to the accompanying drawings.

### First Embodiment

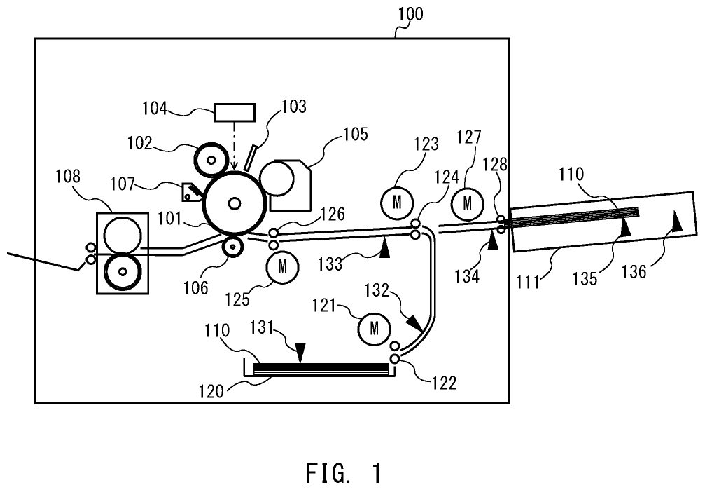

FIG. 1 is a configuration diagram of an image forming apparatus 100 according to a first embodiment of the present disclosure. The image forming apparatus 100 employs an electrophotographic method. The image forming apparatus 100 includes a photosensitive member 101 to be used for image formation, a charging device 102, an exposure device 104, a developing device 105, a transfer unit 106, a cleaner 107, and a fixing device 108. The image forming apparatus 100 includes a potential sensor 103.

In order to feed a sheet 110, the image forming apparatus 100 includes a cassette 120 configured to receive the sheet 110, rollers 122, a manual feed tray 111 on which the sheet 110 is to be placed, rollers 128, conveyance rollers 124, and conveyance rollers 126. A plurality of sensors 132, 133, and 134 are provided on a conveyance path along which the sheet 110 is to be fed. The sensor 132 is arranged on a conveyance path from the cassette 120. The sensor 134 is arranged on a conveyance path from the manual feed tray 111. The sensor 133 is arranged on a conveyance path into which the conveyance path from the cassette 120 and the conveyance path from the manual feed tray 111 are merged. The cassette 120 includes a sensor 131 configured to detect the received sheet 110. The manual feed tray 111 includes sensors 135 and 136 each configured to detect the sheet 110 placed thereon and detect a size of the sheet 110.

The image forming apparatus 100 includes stepping motors 121, 123, 125, and 127 in order to drive the rollers 122, the rollers 128, the conveyance rollers 124, and the conveyance rollers 126. The image forming apparatus 100 has its operation controlled by a controller (not shown).

The photosensitive member 101 is rotated clockwise in FIG. 1. The charging device 102 uniformly charges a surface of the photosensitive member 101 being rotated. The photosensitive member 101 having the surface uniformly charged is exposed by the exposure device 104 in accordance with an image signal, to thereby form thereon an electrostatic latent image corresponding to the image signal. The developing device 105 develops the electrostatic latent image to form a toner image on the surface of the photosensitive member 101. In order to measure a potential of the electrostatic latent image, the potential sensor 103 is provided between the exposure device 104 and the developing device 105. The toner image formed on the surface of the photosensitive member 101 is transferred onto the sheet 110 by the transfer unit 106. Transfer residual toner remaining on the photosensitive member 101 after the transfer is collected by the cleaner 107. The sheet 110 onto which the toner image has been transferred has the toner image fixed by the fixing device 108, and is delivered from the image forming apparatus 100. With the above-mentioned operation, a product on which an image is printed is obtained.

Now, a feeding operation of the sheet 110 is described. In a case of feeding the sheet 110 from the cassette 120, when starting the feeding operation, the controller detects presence or absence of the sheet 110 in the cassette 120 by the sensor 131. When starting the feeding operation with the sheet 110 being present in the cassette 120, the controller starts to feed the sheet 110 received in the cassette 120 by the rollers 122. The controller causes the stepping motor 121 to drive the rollers 122. The rollers 122 convey the sheets 110 one by one from the cassette 120 to the conveyance rollers 124. The sensor 132 is provided on a conveyance path between the rollers 122 and the conveyance rollers 124. The sensor 132 detects whether or not the sheet 110 has passed through a detection position defined on the conveyance path extending from the rollers 122 to the conveyance rollers 124. The controller detects whether or not the sheet 110 has passed through the detection position within a predetermined period based on a detection result of the sensor 132.

In a case where the sheet is fed from the manual feed tray 111, when starting the feeding operation, the controller detects presence or absence and a size of the sheet 110 on the manual feed tray 111 by the sensors 135 and 136. When starting the feeding operation with the sheet 110 being present on the manual feed tray 111, the controller starts to feed the sheet 110 placed on the manual feed tray 111 by the rollers 128. The controller causes the stepping motor 127 to drive the rollers 128. The rollers 128 convey the sheets 110 one by one from the manual feed tray 111 to the conveyance rollers 124. The sensor 134 is provided on a conveyance path between the rollers 128 and the conveyance rollers 124. The sensor 134 detects whether the sheet 110 has passed through a detection position defined on the conveyance path extending from the rollers 128 to the conveyance rollers 124. The controller detects whether or not the sheet 110 has passed through the detection position within a predetermined period based on a detection result of the sensor 134.

The conveyance rollers 124 are rotated by the stepping motor 123. When the sensor 132 or the sensor 134 detects the sheet 110, the controller causes the stepping motor 123 to drive the conveyance rollers 124. The conveyance rollers 124 are thus rotated, to thereby convey the sheet 110, which has been conveyed from the rollers 122 or the rollers 128, to the conveyance rollers 126. The sensor 133 is provided between the conveyance rollers 124 and the conveyance rollers 126 on the conveyance path. The sensor 133 detects whether the sheet 110 has passed through a detection position defined on the conveyance path extending from the conveyance rollers 124 to the conveyance rollers 126. The controller detects whether or not the sheet 110 has passed through the detection position within a predetermined period based on a detection result of the sensor 133.

The conveyance rollers 126 are rotated by the stepping motor 125. When the sensor 133 detects the sheet 110, the controller causes the stepping motor 125 to drive the conveyance rollers 126. The conveyance rollers 126 are thus rotated, to thereby convey the sheet 110, which has been conveyed from the conveyance rollers 124, to the transfer unit 106. A timing at which the conveyance rollers 126 convey the sheet 110 to the transfer unit 106 is adjusted in accordance with a timing at which the toner image formed on the photosensitive member 101 is conveyed to the transfer unit 106. With this adjustment, the toner image is transferred onto the sheet 110 while the sheet 110 and the toner image formed on the photosensitive member 101 pass through the transfer unit 106 in an overlapping state. The controller may also control the conveyance speed of the sheet 110 conveyed by the conveyance rollers 126 so that the toner image on the photosensitive member 101 passes through the transfer unit 106 while overlapping with the sheet 110.

The sensors 131, 132, 133, 134, 135, and 136 in the first embodiment are each formed of, for example, a photo interrupter. In this case, the sensors 131, 132, 133, 134, 135, and 136 each include a light emitting unit (for example, LED) and a light receiving unit (for example, phototransistor) configured to receive light emitted from the light emitting unit.

In regard to one example of the sensors 132, 133, and 134 provided on the conveyance paths, the sheet 110 pushes a flag provided at the detection position on the conveyance path, and an optical path formed between the LED and the phototransistor is blocked by the flag. This blocking causes a change in light reception result obtained by the phototransistor, and the sensors 132, 133, and 134 each detect the presence or absence of the sheet 110 based on the light reception result obtained by the phototransistor. In regard to another example of the sensors 132, 133, and 134 provided on the conveyance paths, the LED and the phototransistor are arranged so as to be opposed to each other across the conveyance path, and the optical path is blocked by the sheet 110 when the sheet 110 passes through the conveyance path. This blocking causes a change in light reception result obtained by the phototransistor, and the sensors 132, 133, and 134 may each be configured to detect the presence or absence of the sheet 110 based on the light reception result obtained by the phototransistor.

The sensors 131, 135, and 136 provided to the cassette 120 and the manual feed tray 111 can detect, for example, an optical path to the phototransistor, which is formed when light emitted from the LED is reflected by the sheet 110. In another case, the sensors 131, 135, and 136 provided to the cassette 120 and the manual feed tray 111 may each be formed of the LED and the phototransistor that are arranged so as to be opposed to each other across the conveyance path, and be configured to detect the presence or absence of the sheet 110 when the sheet 110 is present to block the optical path.

The sensors 132, 133, and 134 provided on the conveyance paths differ from the sensors 131, 135, and 136 provided to the cassette 120 and the manual feed tray 111 in detection cycle period. Specifically, the detection cycle period of each of the sensors 132, 133, and 134 provided on the conveyance paths is shorter than the detection cycle period of each of the sensors 131, 135, and 136 provided to the cassette 120 and the manual feed tray 111.

### Controller

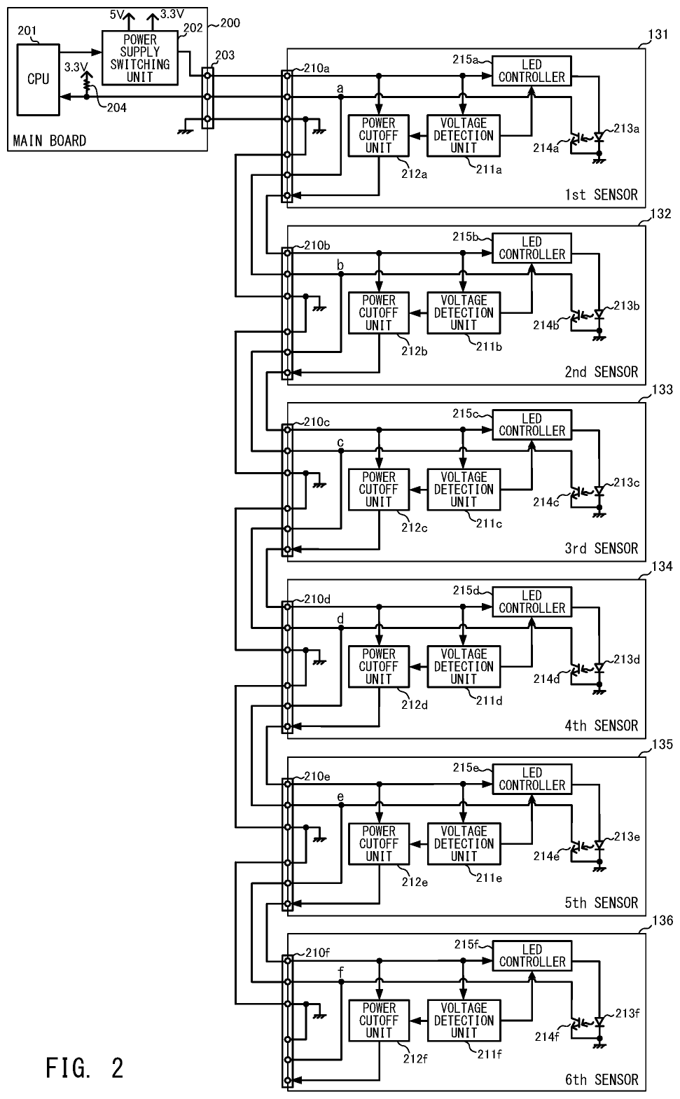

FIG. 2 is a configuration diagram of a main board 200 and sensors that are included in the image forming apparatus 100. The main board 200 is included in the controller of the image forming apparatus 100. In the following description, the sensor 131 is referred to as “first sensor 131”. The sensor 132 is referred to as “second sensor 132”. The sensor 133 is referred to as “third sensor 133”. The sensor 134 is referred to as “fourth sensor 134”. The sensor 135 is referred to as “fifth sensor 135”. The sensor 136 is referred to as “sixth sensor 136”. The main board 200 controls detection operations of the first sensor 131 to the sixth sensor 136, and acquires their detection results.

The first sensor 131 to the sixth sensor 136 are connected in series to the main board 200. This is called “cascade connection”. Assuming that the main board 200 is on an upstream side, the first sensor 131 to the sixth sensor 136 are connected to the main board 200 in order of the first sensor 131, the second sensor 132, the third sensor 133, the fourth sensor 134, the fifth sensor 135, and the sixth sensor 136 from the upstream side. The first sensor 131 to the sixth sensor 136 have the same internal configuration. The main board 200 and the first sensor 131, the first sensor 131 and the second sensor 132, the second sensor 132 and the third sensor 133, the third sensor 133 and the fourth sensor 134, the fourth sensor 134 and the fifth sensor 135, and the fifth sensor 135 and the sixth sensor 136 are respectively connected by different power supply lines and different signal lines. A power supply voltage is applied from the main board 200 to the first sensor 131 to the sixth sensor 136 by the power supply lines. The respective detection results of the first sensor 131 to the sixth sensor 136 are input to the main board 200 by the signal lines. The main board 200, the first sensor 131, the second sensor 132, the third sensor 133, the fourth sensor 134, the fifth sensor 135, and the sixth sensor 136 are connected to a common ground.

The main board 200 includes at least a central processing unit (CPU) 201 configured to control the operations of the first sensor 131 to the sixth sensor 136 and a power supply switching unit 202 configured to switch the power supply voltage to be applied to the first sensor 131 to the sixth sensor 136. The power supply switching unit 202 applies the power supply voltage having three different kinds of voltage values to the first sensor 131 to the sixth sensor 136. The power supply switching unit 202 in the first embodiment switches the power supply voltage (driving voltage for driving the first sensor 131 to the sixth sensor 136) to be applied to the first sensor 131 to the sixth sensor 136 among the following three kinds of voltage values: 0 V, 3.3 V, and 5 V. The power supply switching unit 202 in the first embodiment is a voltage supply circuit configured to supply an initial voltage, a first voltage, and a second voltage to the power supply lines. The main board 200 includes a pull-up resistor 204 for acquiring the detection results of the first sensor 131 to the sixth sensor 136. A predetermined voltage (in this case, 3.3 V) is applied to one end of the pull-up resistor 204. The main board 200 includes a connector 203 for connection to the first sensor 131 through a power supply line.

The first sensor 131 includes a connector 210a, a voltage detection unit 211a, a power cutoff unit 212a, an LED 213a, a phototransistor 214a, and an LED controller 215a. The connector 210a is not only connected to the main board 200 through the power supply line and a signal line, but also connected to the second sensor 132 provided on a downstream side through another power supply line and another signal line.

The voltage detection unit 211a detects the power supply voltage applied from the main board 200, and outputs a control signal for performing conduction control of the power cutoff unit 212a and the LED controller 215a based on the voltage value. The voltage detection unit 211a of the first embodiment is a voltage detection circuit. An operation of the voltage detection unit 211a is described later in detail.

The power cutoff unit 212a includes a switching element on a supply path for supplying the power supply voltage to the sensor (second sensor 132) in the subsequent stage. The power cutoff unit 212a switches a supply state of the power supply voltage applied from the main board 200 to the second sensor 132 in the subsequent stage when the switching element is switched based on the control signal acquired from the voltage detection unit 211a. The switching element is, for example, a metal oxide semiconductor (MOS) field effect transistor (FET). When the voltage of the control signal from the voltage detection unit 211a becomes lower than the power supply voltage applied from the main board 200 by a gate threshold voltage (for example, 1 V), the FET is brought into a cutoff state. Thus, the power cutoff unit 212a inhibits the power supply voltage from being supplied to the second sensor 132 in the subsequent stage.

The LED 213a is a light emitting unit configured to emit light by an electric current flowing based on the power supply voltage applied from the main board 200. The phototransistor 214a is a light receiving unit configured to receive the light emitted from the LED 213a. The state of the phototransistor 214a in the first embodiment is changed from the cutoff state (non-conductive state) to the conductive state when the phototransistor 214a receives the light. A collector terminal of the phototransistor 214a is connected to the pull-up resistor 204 and the CPU 201 of the main board 200 through the signal line. When the state of the phototransistor 214a is the conductive state, a ground voltage (0 V) is input to the CPU 201 as the detection result of the first sensor 131. When the state of the phototransistor 214a is the cutoff state (non-conductive state), the voltage (3.3 V) to be applied to the pull-up resistor 204 is input to the CPU 201 as the detection result of the first sensor 131. The phototransistor 214a is in a high impedance state when being in the cutoff state. In this manner, the CPU 201 can detect the conductive state or the cutoff state (open state) of the phototransistor 214a. The phototransistor 214a is brought into the cutoff state when, for example, the light emitted from the LED 213a is blocked by the sheet 110. The CPU 201 can acquire the detection result of the first sensor 131 based on which one of the conductive state and the cutoff state the state of the phototransistor 214a is.

The LED controller 215a includes a switching element on the path for applying the power supply voltage to the LED 213a. The LED controller 215a switches an application state of the power supply voltage applied from the main board 200 to the LED 213a by switching the switch element based on a control signal acquired from the voltage detection unit 211a. The switching element is, for example, a MOS FET. When the voltage of the control signal from the voltage detection unit 211a becomes lower than the power supply voltage applied from the main board 200 by the gate threshold voltage (for example, 1 V), the FET is brought into a cutoff state, and the LED controller 215a does not apply the power supply voltage to the LED 213a. When the power supply voltage is not applied to the LED 213a, an electric current does not flow therethrough, with the result that the LED 213a does not emit light.

Now, the operation of the voltage detection unit 211a is described. The voltage detection unit 211a detects falling of the power supply voltage applied from the main board 200 with, for example, a threshold value of 4 V. The voltage detection unit 211a is in a “first state” in an initial state at power-on, and maintains the first state until the falling of the applied power supply voltage across 4 V is detected after the applied power supply voltage temporarily becomes equal to or higher than 4 V (for example, 5 V). The voltage detection unit 211a detects the falling across 4 V when the applied power supply voltage decreases from 5 V to 3.3 V. In this case, the voltage detection unit 211a is brought into a “second state”. The voltage detection unit 211a that has been brought into the second state maintains the second state until the power supply voltage applied from the main board 200 changes to 0 V irrespective of the applied power supply voltage. The changing of the power supply voltage applied from the main board 200 to 0 V is referred to as “initialization”. In order for the voltage detection unit 211a to be brought into the initial state, the main board 200 may be configured to cut off the power supply voltage at this time.

While being in the initial state (first state) at power-on, the voltage detection unit 211a controls the power cutoff unit 212a to be in a cutoff state in which the power supply voltage is not supplied to the second sensor 132 on the downstream side. While being in the second state, the voltage detection unit 211a controls the power cutoff unit 212a to be in a conductive state in which the power supply voltage is supplied to the second sensor 132 on the downstream side. While being in the first state, the voltage detection unit 211a controls the LED controller 215a to be in a conductive state in which an electric current is supplied to the LED 213a to cause the LED 213a to emit light. While being in the second state, the voltage detection unit 211a controls the LED controller 215a to be in a cutoff state in which the electric current supplied to the LED 213a is cut off to cause the LED 213a to turn out the light.

A connector 210b of the second sensor 132 is not only connected to the first sensor 131 on the upstream side through the power supply line and the signal line, but also connected to the third sensor 133 provided on the downstream side through another power supply line and another signal line. The second sensor 132 includes a voltage detection unit 211b, a power cutoff unit 212b, an LED 213b, a phototransistor 214b, and an LED controller 215b. Operations of the respective components are the same as the operations of the respective corresponding components of the first sensor 131, and hence descriptions thereof are omitted.

A collector terminal of the phototransistor 214b of the second sensor 132 is connected to the signal line for connecting the collector terminal of the phototransistor 214a and the connector 210a at a contact “a” in the first sensor 131. Therefore, an output value of the signal line for connecting the first sensor 131 and the main board 200 is variable based on an output value of the phototransistor 214b.

A connector 210c of the third sensor 133 is not only connected to the second sensor 132 on the upstream side through the power supply line and the signal line, but also connected to the fourth sensor 134 provided on the downstream side through another power supply line and another signal line. The third sensor 133 includes a voltage detection unit 211c, a power cutoff unit 212c, an LED 213c, a phototransistor 214c, and an LED controller 215c. Operations of the respective components are the same as the operations of the respective corresponding components of the first sensor 131, and hence descriptions thereof are omitted.

A collector terminal of the phototransistor 214c of the third sensor 133 is connected to the signal line for connecting the collector terminal of the phototransistor 214b and the connector 210b at a contact “b” in the second sensor 132. The contact “b” is connected to the contact “a” in the first sensor 131. Therefore, an output value of the signal line for connecting the first sensor 131 and the main board 200 is variable based on an output value of the phototransistor 214c.

A connector 210d of the fourth sensor 134 is not only connected to the third sensor 133 on the upstream side through the power supply line and the signal line, but also connected to the fifth sensor 135 provided on the downstream side through another power supply line and another signal line. The fourth sensor 134 includes a voltage detection unit 211d, a power cutoff unit 212d, an LED 213d, a phototransistor 214d, and an LED controller 215d. Operations of the respective components are the same as the operations of the respective corresponding components of the first sensor 131, and hence descriptions thereof are omitted.

A collector terminal of the phototransistor 214d of the fourth sensor 134 is connected to the signal line for connecting the collector terminal of the phototransistor 214c and the connector 210c at a contact “c” in the third sensor 133. The contact “c” is connected to the contact “a” in the first sensor 131 via the contact “b” in the second sensor 132. Therefore, an output value of the signal line for connecting the first sensor 131 and the main board 200 is variable based on an output value of the phototransistor 214d.

A connector 210e of the fifth sensor 135 is not only connected to the fourth sensor 134 on the upstream side through the power supply line and the signal line, but also connected to the sixth sensor 136 provided on the downstream side through another power supply line and another signal line. The fifth sensor 135 includes a voltage detection unit 211e, a power cutoff unit 212e, an LED 213e, a phototransistor 214e, and an LED controller 215e. Operations of the respective components are the same as the operations of the respective corresponding components of the first sensor 131, and hence descriptions thereof are omitted.

A collector terminal of the phototransistor 214e of the fifth sensor 135 is connected to the signal line for connecting the collector terminal of the phototransistor 214d and the connector 210d at a contact “d” in the fourth sensor 134. The contact “d” is connected to the contact “a” in the first sensor 131 via the contact “b” in the second sensor 132 and the contact “c” in the third sensor 133. Therefore, an output value of the signal line for connecting the first sensor 131 and the main board 200 is variable based on an output value of the phototransistor 214e.

A connector 210f of the sixth sensor 136 is connected to the fifth sensor 135 on the upstream side through the power supply line and the signal line. The sixth sensor 136 is arranged on the most downstream side of the series connection, and hence the connector 210f is not connected to any component in the subsequent stage. The sixth sensor 136 includes a voltage detection unit 21 if, a power cutoff unit 212f, an LED 213f, a phototransistor 214f, and an LED controller 215f. Operations of the respective components are the same as the operations of the respective corresponding components of the first sensor 131, and hence descriptions thereof are omitted.

A collector terminal of the phototransistor 214f of the sixth sensor 136 is connected to the signal line for connecting the collector terminal of the phototransistor 214e and the connector 210e at a contact “e” in the fifth sensor 135. The contact “e” is connected to the contact “a” in the first sensor 131 via the contact “b” to the contact “d” in the second sensor 132 to the fourth sensor 134, respectively. Therefore, an output value of the signal line for connecting the first sensor 131 and the main board 200 is variable based on an output value of the phototransistor 214f.

With the above-mentioned configuration, the first sensor 131 to the sixth sensor 136 perform the same operation on the input signal (power supply voltage). However, through shifting of a timing to supply power to the respective sensors, the CPU 201 can independently detect the states of all the sensors. The main board 200 alternately applies two kinds of power supply voltages (5 V and 3.3 V) to a plurality of sensors, to thereby cause the respective sensors to sequentially perform the detection operations. For example, the main board 200 applies the power supply voltage while sequentially switching the power supply voltages having the respective voltage values irrespective of the conveyance timing of the sheet 110.

The main board 200 resets the states of the respective sensors by applying another power supply voltage (0 V), and causes the sensors to again perform the detection operations sequentially from the first stage. Each sensor can use the same interface for connection to the main board 200 or another sensor irrespective of a connection point (most upstream, most downstream, or halfway) in the series connection. Therefore, sensors of the same kind (of the same outer shape and having the same internal circuit) can be used for all the sensors. The number of sensors connected in series to the main board 200 in the first embodiment is six, but it is also possible to further increase the number of sensors under the same control.

Through such connection of the power supply line and the signal line, it is possible to suppress lengths of the power supply line and the signal line for connecting the main board 200 and the plurality of sensors (first sensor 131 to sixth sensor 136). That is, a plurality of sensors of the same kind (of the same outer shape and having the same internal circuit) are connected in series. The respective sensors can independently perform the detection operations. Therefore, it is possible to shorten the length of a cable, and suppress costs including a component management cost. It is also possible to cut the costs by reducing the number of pins of the connector 203 of the main board 200 and an occupied area thereof.

### Operation Control of Sensors

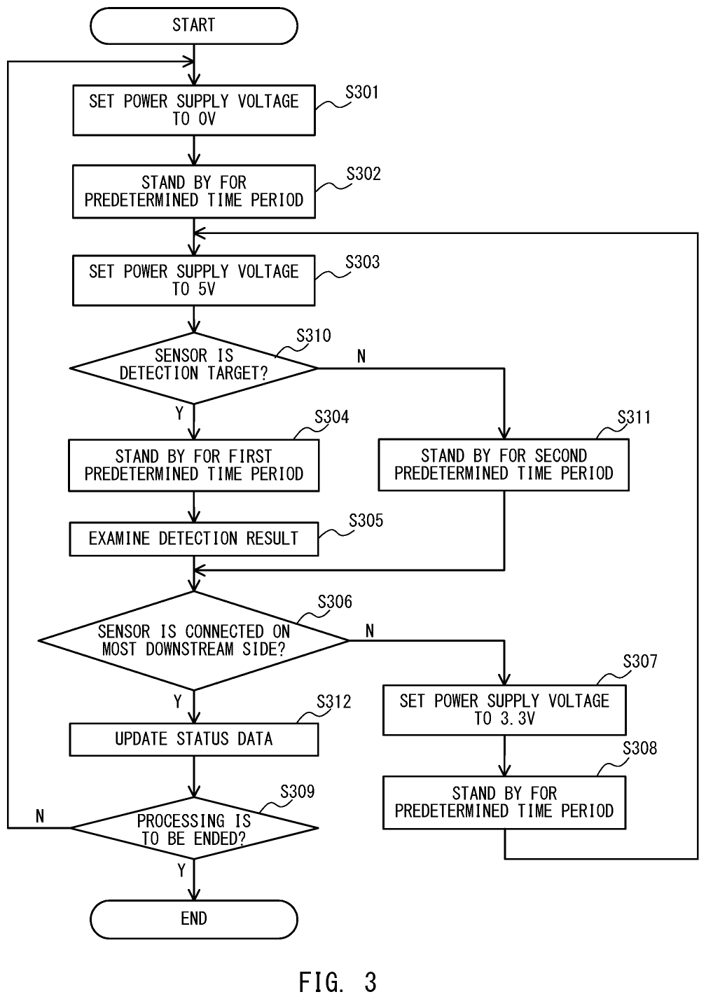

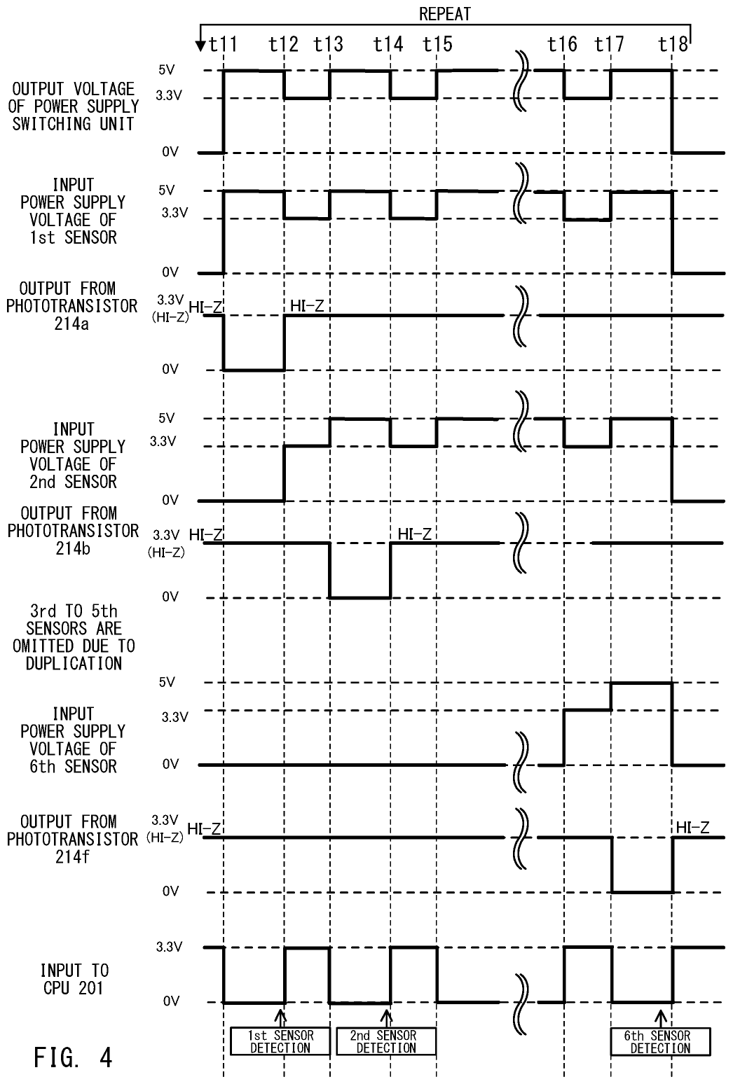

FIG. 3 is a flow chart for illustrating operation control processing for a sensor, which is performed by the main board 200. FIG. 4 is a timing chart exhibited when operations of the sensors are controlled.

When the sensor has started a detection operation, the CPU 201 first sets the power supply voltage output by the power supply switching unit 202 to 0 V (Step S301). The CPU 201 stands by for a predetermined time period (for example, 100 microseconds) while maintaining the power supply voltage at 0 V (Step S302). The predetermined time period is set as a time period long enough to control the power cutoff units 212a to 212f to a cutoff state (a state in which the power supply voltage is not supplied to the second sensor 132 to the sixth sensor 136) being an initial state. In Step S301, the CPU 201 may set the power supply voltage to 0 V by cutting off the power supply voltage.

When the predetermined time period has elapsed since the power supply voltage was set to 0 V, the CPU 201 sets the power supply voltage output by the power supply switching unit 202 to 5 V (Step S303). At this time, the voltage detection unit 211a is in the first state, and the LED controller 215a causes the LED 213a to emit light. The power cutoff unit 212a is in the cutoff state, and hence the power supply voltage is not supplied to the sensor on the downstream side. The CPU 201 determines whether or not the sensor being currently operated is a sensor from which a detection result is to be acquired (Step S310). This determination processing is performed based on the status data to be described later. The processing of Step S310 is to be described later in detail.

When the sensor being currently operated is not a sensor from which a detection result is to be acquired (N in Step S310), the CPU 201 stands by for a second predetermined time period (for example, 10 microseconds) while maintaining the power supply voltage at 5 V (Step S311). The processing of Step S311 is to be described later in detail.

When the sensor being currently operated is a sensor from which a detection result is to be acquired (Y in Step S310), the CPU 201 stands by for a first predetermined time period (for example, 100 microseconds) while maintaining the power supply voltage at 5 V (Step S304). The first predetermined time period is set as a time period longer than a time period to be taken after the power supply voltage is applied to the first sensor 131 until the detection result obtained from the first sensor 131 is input to the CPU 201. Meanwhile, the second predetermined time period is set as a time period shorter than the time period to be taken after the power supply voltage is applied to the first sensor 131 until the detection result obtained from the first sensor 131 is input to the CPU 201.

After a lapse of the first predetermined time period, the CPU 201 acquires the voltage value of the signal line to examine the detection result of the first sensor 131 (Step S305). With the processing of Step S305, the CPU 201 detects whether the phototransistor 214a of the first sensor 131 is in the conductive state or the cutoff state. The phototransistor 214b of the second sensor 132 to the phototransistor 214f of the sixth sensor 136 are also connected to the signal line for connecting the phototransistor 214a and the CPU 201. However, the power cutoff unit 212a of the first sensor 131 is in the cutoff state, and hence the power supply voltage is not supplied to the second sensor 132 to the sixth sensor 136. With this arrangement, while the CPU 201 is acquiring the light reception result obtained by the phototransistor 214a, the output value of the signal line changes based only on the light reception result obtained by the phototransistor 214a.

When the output value of the signal line is 0 V, the CPU 201 determines that the phototransistor 214a of the first sensor 131 is in the conductive state. That is, when the output value of the signal line is 0 V, the first sensor 131 has not detected the sheet 110. When the output value of the signal line is 3.3 V, the CPU 201 determines that the phototransistor 214a of the first sensor 131 is in the cutoff state. That is, when the output value of the signal line is 3.3 V, the first sensor 131 has detected the sheet 110. In this manner, the CPU 201 acquires the output value of the signal line in the processing of Step S305, to thereby be able to determine the detection result of the first sensor 131.

The processing from Step S303 to Step S305 is processing performed between a time t11 and a time t12 in FIG. 4. In the example of FIG. 4, waveforms exhibited when the light emitted from the LED 213a is received by the phototransistor 214a are illustrated. That is, the output value of the signal line is 0 V. When a shielding object is provided between the LED 213a and the phototransistor 214a, the phototransistor 214a is brought into the cutoff state, and the output value of 3.3 V is detected.

After acquiring the detection result, the CPU 201 determines whether or not the sensor from which the detection result has been acquired is connected on the most downstream side of the series connection (Step S306). For example, the number of sensors connected in series is registered in the CPU 201 in advance, and the CPU 201 determines based on the number of sensors and the number of the acquired detection results whether or not the sensor from which the detection result has been acquired is connected on the most downstream side. When the number of detection results is smaller than the number of sensors, the CPU 201 determines that the sensor from which the detection result has been acquired is not the sensor on the most downstream side. Meanwhile, when the number of detection results is the same as the number of sensors, the CPU 201 determines that the sensor from which the detection result has been acquired is the sensor on the most downstream side.

When the sensor from which the detection result has been acquired is not the sensor on the most downstream side (N in Step S306), the CPU 201 controls the power supply switching unit 202 to switch the power supply voltage from 5 V to 3.3 V (Step S307). At this time, the voltage detection unit 211a detects the falling of the power supply voltage, and is therefore changed from the first state to the second state. The voltage detection unit 211a subsequently maintains the second state until the power supply voltage reaches 0 V. When the voltage detection unit 211a is brought into the second state, the power cutoff unit 212a is brought into the conductive state, and is controlled to allow the power supply voltage to be supplied to the second sensor 132 provided on the downstream side. The LED controller 215a of the first sensor 131 is brought into the cutoff state to cut off the current supply to the LED 213a. Therefore, the LED 213a of the first sensor 131 turns out the light. In short, the phototransistor 214a is brought into the cutoff state.

The CPU 201 stands by for a predetermined time period (for example, 75 microseconds) while maintaining the power supply voltage at 3.3 V (Step S308). It suffices that the predetermined time period is a time period required for changing the state of the voltage detection unit 211a of the first sensor 131 to the second state. The processing from Step S306 to Step S308 is processing performed between the time t12 and a time t13 in FIG. 4.

When the power cutoff unit 212a of the first sensor 131 is brought into the conductive state, the power supply voltage can be supplied to the second sensor 132. When the supply of the power supply voltage is started, the voltage detection unit 211b of the second sensor 132 is controlled to the first state being the initial state. The power cutoff unit 212b of the second sensor 132 is controlled to the cutoff state. The LED controller 215b of the second sensor 132 is brought into the conductive state. The LED 213b emits light by the electric current supplied thereto.

After a lapse of a predetermined time period, the CPU 201 again performs the processing from Step S303 to Step S306. With this processing, the CPU 201 acquires the detection result of the second sensor 132. In the processing of Step S305, the phototransistor 214a of the first sensor 131 and the phototransistor 214c of the third sensor 133 to the phototransistor 214f of the sixth sensor 136 are controlled to a non-operation state, and is in the open state. Therefore, the output value of the signal line changes based only on the light reception result obtained by the phototransistor 214b of the second sensor 132. The processing from Step S303 to Step S305 is processing performed between the time t13 and a time t14 in FIG. 4.

After acquiring the detection result of the second sensor 132, the CPU 201 determines whether or not the detection result has been acquired from the sensor connected on the most downstream side of the series connection (Step S306). In this case, the detection result has been acquired from the second sensor 132, and hence the CPU 201 again performs the processing of Step S307 and Step S308. With this processing, the power supply voltage is supplied to the third sensor 133. The processing from Step S306 to Step S308 is processing performed between the time t14 and a time t15 in FIG. 4.

The CPU 201 again performs the processing from Step S303 to Step S305 on the third sensor 133. With this processing, the CPU 201 acquires the detection result of the third sensor 133. In the processing of Step S305, the phototransistor 214a of the first sensor 131, the phototransistor 214b of the second sensor 132, and the phototransistor 214d of the fourth sensor 134 to the phototransistor 214f of the sixth sensor 136 are controlled to a non-operation state, and is in the open state. Therefore, the output value of the signal line changes based only on the light reception result obtained by the phototransistor 214c of the third sensor 133. The processing from Step S303 to Step S305 is processing performed after the time t15 in FIG. 4.

The CPU 201 also acquires the detection results of the fourth sensor 134 to the sixth sensor 136 by the same processing. However, the sixth sensor 136 is the sensor on the most downstream side. Therefore, the CPU 201 determines that the detection result has been acquired from the sensor connected on the most downstream side of the series connection (Y in Step S306). The CPU 201, which has acquired the detection result of the sensor on the most downstream side, updates the status data (Step S312). The status data is described later in detail.

When the detection operation is to be brought to an end (Y in Step S309), the CPU 201 brings the processing to an end. In the above-mentioned manner, the CPU 201 acquires the detection result of the sensor at a timing before changing the power supply voltage from 5 V to 3.3 V, to thereby be able to acquire a stable detection result.

When the detection operation is to be continued (N in Step S309), the CPU 201 returns to the processing of Step S301 to set the power supply voltage output by the power supply switching unit 202 to 0 V, and stands by for a predetermined time period. With this processing, the respective states of the voltage detection units 21a to 211f of the first sensor 131 to the sixth sensor 136, which are connected in series, are initialized to be brought into the first state. The power cutoff units 212a to 212f are brought into the cutoff state being the initial state, to thereby cut off the power supply voltage supplied to the sensor on the downstream side. The CPU 201 repeatedly performs the processing from Step S303 to Step S309, to thereby be able to detect the states of the first sensor 131 to the sixth sensor 136 at all times. In this manner, the first sensor 131 to the sixth sensor 136 perform the detection operation in order.

With the above-mentioned processing, the first sensor 131 to the sixth sensor 136 perform the same operation on the input signal (power supply voltage). However, through shifting of the timing to supply power to the respective sensors, the CPU 201 can independently detect the states of all the sensors sequentially.

Each sensor can also use the same interface for connection to the main board 200 or another sensor irrespective of the connection point (most upstream, most downstream, or halfway) in the series connection. Therefore, sensors of the same kind (of the same outer shape and having the same internal circuit) can be used as all the sensors. The main board 200 is not required to manage the correspondence between the connection point and the sensor. The sensors are not required to have outer shapes individually changed, and each have an inexpensive configuration that does not require a complicated control circuit for, e.g., packet communication. The number of sensors connected in series to the main board 200 in the first embodiment is six, but it is also possible to further increase the number of sensors under the same control.

When it is determined in the processing of Step S310 that the sensor being currently operated is not a sensor from which a detection result is to be acquired, the CPU 201 skips detection processing to be performed by the sensor. In this case, a description is given of an exemplary case of skipping the detection processing to be performed by the first sensor 131.

As described above, the time period (first predetermined time period) during which the power supply voltage is maintained at 5 V is set as a time period longer than the time period to be taken after the power supply voltage is applied to the first sensor 131 until the detection result obtained from the first sensor 131 is input to the CPU 201. This is because an accurate detection result cannot be obtained when a time period taken after the power supply voltage is applied to the first sensor 131 until the detection result is acquired is too short in comparison with a response speed of the first sensor 131.

However, it is not required to consider the response speed of the first sensor 131 when the first sensor 131 is not a sensor from which a detection result is to be acquired and the detection result is not required. In this case, it suffices that the time period (second predetermined time period) during which the power supply voltage is maintained at 5 V is a time period long enough for the voltage detection unit 211a to detect that the power supply voltage has been changed to 5 V. That is, the sensor from which a detection result is not required to be acquired does not have any problem in terms of operation even when the time period during which the power supply voltage is maintained at 5 V is shortened. Therefore, through shortening of a waiting time period (second predetermined time period), it is possible to shorten the time period to be taken until a power supply destination is switched to the subsequent sensor (second sensor 132).

As described with reference to the flow chart of FIG. 3, when the sensor being currently operated is not a sensor from which a detection result is to be acquired (N in Step S310), the CPU 201 stands by for the second predetermined time period while maintaining the power supply voltage at 5 V (Step S311). The second predetermined time period is set as a required time period long enough for the voltage detection units 211a, 211b, 211c, 211d, 211e, and 211f to detect that the power supply voltage has been changed to 5 V. When the second predetermined time period has elapsed, the CPU 201 performs the processing of Step S306 without examining the detection result of the sensor.

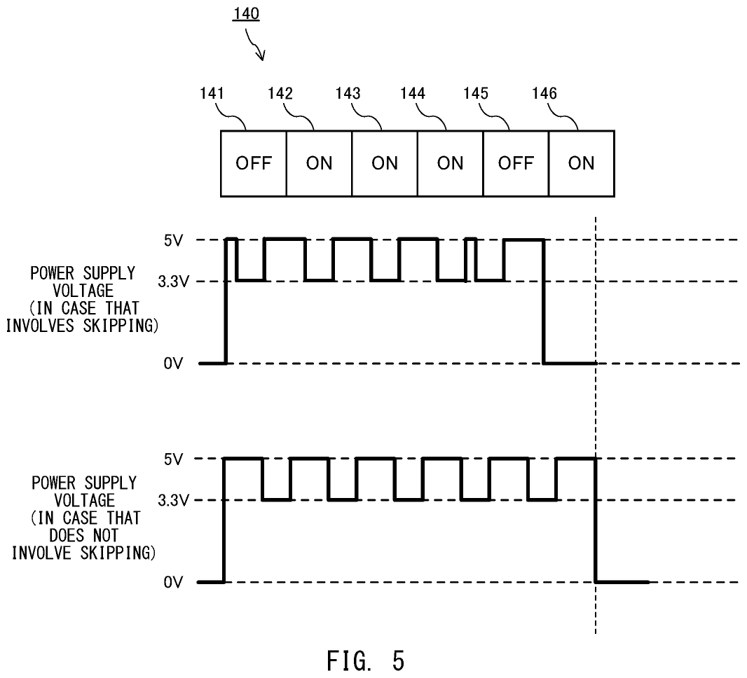

FIG. 5 is an explanatory diagram of a power supply voltage exhibited when the detection processing is to be skipped. In FIG. 5, status data 140 for indicating a target from which a detection result is to be acquired and power supply voltages output from the power supply switching unit 202 are illustrated. The status data 140 is stored in the CPU 201, and includes status information pieces 141 to 146 each indicating whether or not each corresponding one of the first sensor 131 to the sixth sensor 136, respectively, is the target from which a detection result is to be acquired.

The CPU 201 controls a time period for outputting the power supply voltage from the power supply switching unit 202 based on the status information pieces 141 to 146. In the status data 140, “ON” indicates that the sensor is the target from which a detection result is to be acquired, while “OFF” indicates that the sensor is not the target. In the case of FIG. 5, the status data 140 is set so as to skip two sensors (first sensor 131 and fifth sensor 135). In other words, the status information pieces 141 and 145 are set to “OFF”. In the processing of Step S310, the CPU 201 uses the sensor being currently operated and the status data 140 to determine whether or not the sensor is the target from which a detection result is to be acquired.

In the status data 140 at this time, the detection operations of two sensors are omitted, and hence a total time period to be taken until one round of the detection operations performed by all the sensors is finished can be made shorter than in a case that does not involve the skipping. In the example of FIG. 5, a time period for applying the power supply voltage of 5 V to the first sensor 131 and the fifth sensor 135 becomes shorter in a case that involves the skipping than in the case that does not involve the skipping. The total time period required for the detection operations performed by all the sensors becomes shorter by the shortened amount of time.

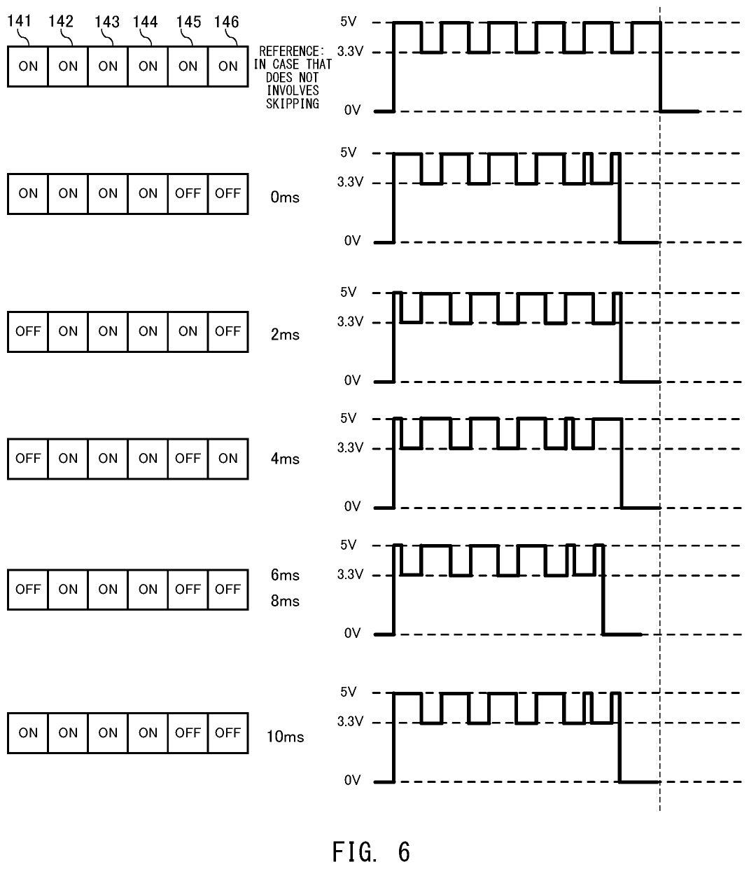

FIG. 6 is an explanatory diagram of a power supply voltage exhibited when there coexist sensors having different detection cycle periods. The sensors having a relatively short detection cycle period are not skipped, while the sensors having a relatively long detection cycle period are skipped. The sensors having a relatively short detection cycle period are the second sensor 132 to the fourth sensor 134 that are provided on the conveyance path of the sheet 110. The detection cycle period of each of the second sensor 132 to the fourth sensor 134 is, for example, 2 milliseconds. The sensors having a relatively long detection cycle period are the first sensor 131, the fifth sensor 135, and the sixth sensor 136 that are provided at positions at each of which the sheet 110 is received or placed. The detection cycle period of each of the first sensor 131, the fifth sensor 135, and the sixth sensor 136 is, for example, 10 milliseconds. It suffices that the first sensor 131, the fifth sensor 135, and the sixth sensor 136 each perform the detection operation at least one time during a period of 10 milliseconds, and those sensors may be skipped in the other rounds.

When any one of the first sensor 131, the fifth sensor 135, and the sixth sensor 136 is operated, the operations of the other two are skipped. Therefore, the operations of two sensors can be skipped in one round for operating all the sensors, which shortens a detection time period of one round for operating all the sensors. In order to switch the sensor to be skipped, the CPU 201 updates the status data 140 in the processing of Step S312.

Through shortening of the detection time period, it is possible to increase the number of sensors that can perform the detection operation with the same detection time period of one round. In the first embodiment, the detection cycle periods are a combination of 2 milliseconds and 10 milliseconds, but the present disclosure is not limited thereto, and the detection time period can be shortened by similar processing. In a case where the detection result of a specific one of a pair of sensors is required while the detection result of the other one of the pair of sensors is not required or in other such cases of functionally exclusive sensors, it is also possible to shorten the detection time period per round by constantly skipping any one of the pair.

### Second Embodiment

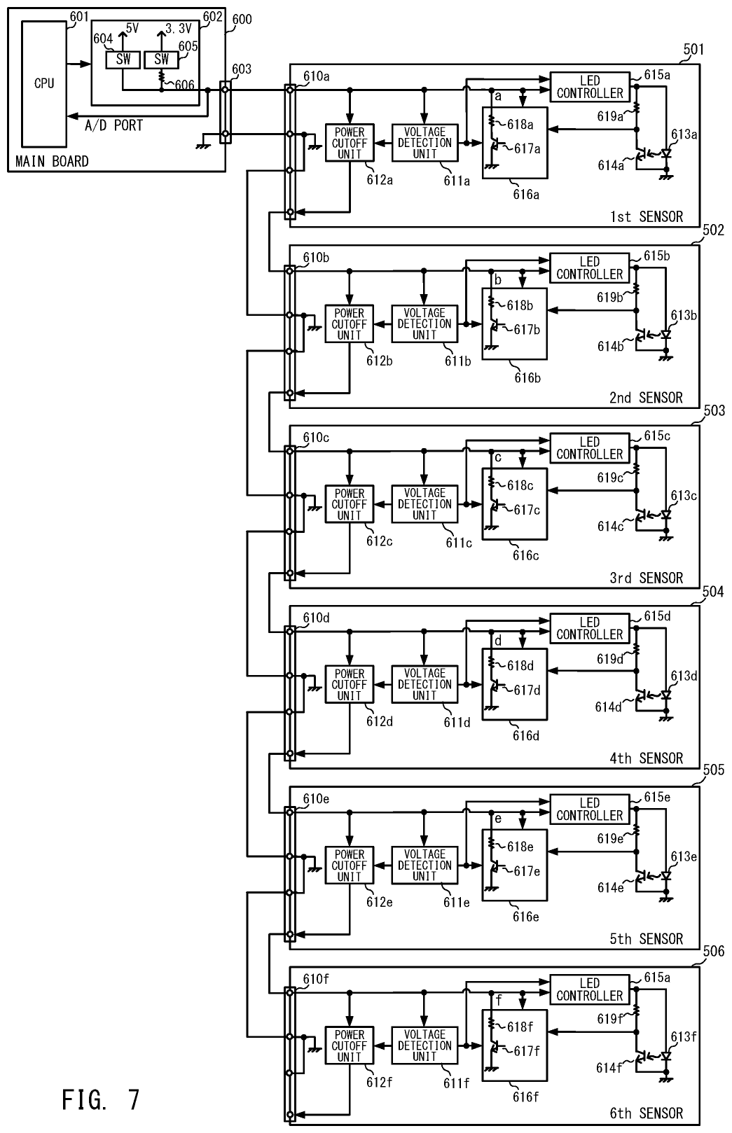

A second embodiment of the present disclosure is different from the first embodiment in configurations of the main board and the sensors, but the configuration of the image forming apparatus 100 itself is the same. Therefore, the description of the configuration of the image forming apparatus 100 is omitted. FIG. 7 is a configuration diagram of a main board included in the controller and sensors in the second embodiment. A main board 600 controls operations of a first sensor 501 to a sixth sensor 506 to acquire detection results of those sensors. The first sensor 501 corresponds to the first sensor 131. The second sensor 502 corresponds to the second sensor 132. The third sensor 503 corresponds to the third sensor 133. The fourth sensor 504 corresponds to the fourth sensor 134. The fifth sensor 505 corresponds to the fifth sensor 135. The sixth sensor 506 corresponds to the sixth sensor 136.

The first sensor 501 to the sixth sensor 506 are connected in series to the main board 600. Assuming that the main board 600 is on an upstream side, the first sensor 501 to the sixth sensor 506 are connected to the main board 600 in order of the first sensor 501, the second sensor 502, the third sensor 503, the fourth sensor 504, the fifth sensor 505, and the sixth sensor 506 from the upstream side. The first sensor 501 to the sixth sensor 506 have the same internal configuration. The main board 600 and the first sensor 501, the first sensor 501 and the second sensor 502, the second sensor 502 and the third sensor 503, the third sensor 503 and the fourth sensor 504, the fourth sensor 504 and the fifth sensor 505, and the fifth sensor 505 and the sixth sensor 506 are respectively connected by different power supply lines. A power supply voltage is applied from the main board 600 to the first sensor 501 to the sixth sensor 506 by the power supply lines. Further, the respective detection results of the first sensor 501 to the sixth sensor 506 are input to the main board 600 by the power supply lines. The main board 600, the first sensor 501, the second sensor 502, the third sensor 503, the fourth sensor 504, the fifth sensor 505, and the sixth sensor 506 are connected to a common ground.

The main board 600 includes at least a CPU 601 configured to control the operations of the first sensor 501 to the sixth sensor 506 and a power supply switching unit 602 configured to switch the power supply voltage to be applied to the first sensor 501 to the sixth sensor 506. Similarly to the first embodiment, the power supply switching unit 602 applies the power supply voltage having three different kinds of voltage values to the first sensor 501 to the third sensor 503. The power supply switching unit 202 in the second embodiment switches the power supply voltage to be applied to the first sensor 501 to the third sensor 503 among the following three kinds of voltage values: 0 V, 3.3 V, and 5 V. The power supply switching unit 602 includes two switch units (SW) 604 and 605. When the switch unit 604 is in a conductive state and the switch unit 605 is in a cutoff state, the power supply voltage is 5 V. When the switch unit 604 is in a cutoff state and the switch unit 605 is in a conductive state, the power supply voltage is 3.3 V. When both the switch units 604 and 605 are in a cutoff state, the power supply voltage is 0 V. The main board 600 includes, in the power supply switching unit 602, a pull-up resistor 606 for acquiring the detection results of the first sensor 501 to the sixth sensor 506. A predetermined voltage (in this case, 3.3 V) is applied to one end of the pull-up resistor 606 via the switch unit 605. The main board 600 includes a connector 603 for connection to the first sensor 131 through the power supply line.

The first sensor 501 includes a connector 610a, a voltage detection unit 611a, a power cutoff unit 612a, an LED 613a, a phototransistor 614a, an LED controller 615a, a sensor latch unit 616a, and a pull-up resistor 619a. The first sensor 501 in the second embodiment has a configuration obtained by adding the sensor latch unit 616a and the pull-up resistor 619a to the first sensor 131 in the first embodiment. The pull-up resistor 619a is configured to pull up a collector of the phototransistor 614a. Now, differences from the first embodiment are described.

The sensor latch unit 616a includes a transistor 617a functioning as a switching element and a resistor 618a. The transistor 617a in the sensor latch unit 616a operates based on the state of the voltage detection unit 611a and the operation of the phototransistor 614a. A collector terminal of the transistor 617a is connected to the power supply line of the first sensor 501 at a contact “a” via the resistor 618a. The power supply line connected at the contact “a” is connected to an A/D port of the CPU 601. With such a configuration, the CPU 601 can detect the conductive state or the cutoff state (open state) of the transistor 617a.

The connector 610a is not only connected to the main board 600 through the power supply line, but also connected to the second sensor 502 provided on the downstream side through another power supply line. Unlike in the first embodiment, no signal line is connected to the connector 610a.

The voltage detection unit 611a detects each of rising and falling of the power supply voltage applied from the main board 600 with, for example, a threshold value of 4 V. However, the voltage detection unit 611a does not detect the rising when the voltage changes from 0 V to at least 4 V at power-on. The voltage detection unit 611a is in a “first state” in an initial state at power-on, and maintains the first state until the falling of the applied power supply voltage across 4 V is detected after the applied power supply voltage temporarily becomes equal to or higher than 4 V (for example, 5 V). When the falling of the applied power supply voltage across 4 V is detected, the voltage detection unit 611a is brought into a “second state”. After that, when the rising of the applied power supply voltage across 4 V is detected, the voltage detection unit 611a is brought into a “third state”. The voltage detection unit 611a that has been brought into the third state maintains the third state until the power supply voltage changes to 0 V. The changing of the power supply voltage to 0 V is referred to as “initialization”. In order for the voltage detection unit 611a to be brought into the initial state, the main board 600 may be configured to cut off the power supply voltage.

When the voltage detection unit 611a is in the initial state (first state) at power-on, the power cutoff unit 612a is brought into the cutoff state in which the power supply voltage is not supplied to the second sensor 502 on the downstream side. When the voltage detection unit 611a is in the second state, the power cutoff unit 612a is also in the cutoff state. When the voltage detection unit 611a is brought into the third state, the power cutoff unit 612a is brought into the conductive state in which the power supply voltage is supplied to the second sensor 502 on the downstream side.

When the voltage detection unit 611a is in the first state, the LED controller 615a is brought into the conductive state, and supplies an electric current to the LED 613a to cause the LED 613a to emit light. When the voltage detection unit 611a is brought into the second state, the LED controller 615a is brought into the cutoff state, and cuts off the electric current supplied to the LED 613a to turn out the light. Even when the voltage detection unit 611a is brought into the third state after that, the LED controller 615a maintains the cutoff state until the power supply voltage is changed to 0 V (is initialized).

When the voltage detection unit 611a is in the first state, the transistor 617a of the sensor latch unit 616a is brought into a cutoff state. When the voltage detection unit 611a is switched from the first state to the second state, the sensor latch unit 616a latches a state signal obtained from the phototransistor 614a, and operates the transistor 617a based on the latched result.

In a case where the phototransistor 614a is in the conductive state (with an input of 0 V) when the voltage detection unit 611a is switched from the first state to the second state, the sensor latch unit 616a maintains the transistor 617a in a conductive state. When the phototransistor 614a is in the cutoff state (with an input at a power supply voltage level), the sensor latch unit 616a maintains the transistor 617a in a cutoff state.

When the voltage detection unit 6111a is switched to the third state after that, the sensor latch unit 616a brings the transistor 617a into the cutoff state. The sensor latch unit 616a maintains this state until the power supply voltage is changed to 0 V (initialized). In this manner, the sensor latch unit 616a can maintain a light receiving state of the phototransistor 614a.

A connector 610b of the second sensor 502 is not only connected to the first sensor 501 on the upstream side through the power supply line, but also connected to the third sensor 503 provided on the downstream side through another power supply line. To the connector 610b, such a signal line as described in the first embodiment is not connected. The second sensor 502 includes a voltage detection unit 611b, a power cutoff unit 612b, an LED 613b, a phototransistor 614b, an LED controller 615b, a sensor latch unit 616b, and a pull-up resistor 619b. Operations of the respective components are the same as the operations of the respective corresponding components of the first sensor 501, and hence descriptions thereof are omitted.

A collector terminal of a transistor 617b in the sensor latch unit 616b is connected to the power supply line of the second sensor 502 at a contact “b” via a resistor 618b. The contact “b” is connected to the A/D port of the CPU 601 of the main board 600 via the first sensor 501. With such a configuration, the CPU 601 can detect a conductive state or a cutoff state of the transistor 617b.

A connector 610c of the third sensor 503 is not only connected to the second sensor 502 on the upstream side through the power supply line, but also connected to the fourth sensor 504 provided on the downstream side through another power supply line. The connector 610c is not connected to such a signal line as used in the first embodiment. The third sensor 503 includes a voltage detection unit 611c, a power cutoff unit 612c, an LED 613c, a phototransistor 614c, an LED controller 615c, a sensor latch unit 616c, and a pull-up resistor 619c. Operations of the respective components are the same as the operations of the respective corresponding components of the first sensor 501, and hence descriptions thereof are omitted.

A collector terminal of a transistor 617c in the sensor latch unit 616c is connected to the power supply line of the third sensor 503 at a contact “c” via a resistor 618c. The contact “c” is connected to the A/D port of the CPU 601 of the main board 600 via the first sensor 501 and the second sensor 502. With such a configuration, the CPU 601 can detect a conductive state or a cutoff state of the transistor 617c.

A connector 610d of the fourth sensor 504 is not only connected to the third sensor 503 on the upstream side through the power supply line, but also connected to the fifth sensor 505 provided on the downstream side through another power supply line. To the connector 610d, such a signal line as described in the first embodiment is not connected. The fourth sensor 504 includes a voltage detection unit 611d, a power cutoff unit 612d, an LED 613d, a phototransistor 614d, an LED controller 615d, a sensor latch unit 616d, and a pull-up resistor 619d. Operations of the respective components are the same as the operations of the respective corresponding components of the first sensor 501, and hence descriptions thereof are omitted.

A collector terminal of a transistor 617d in the sensor latch unit 616d is connected to the power supply line of the third sensor 504 at a contact “d” via a resistor 618d. The contact “d” is connected to the A/D port of the CPU 601 of the main board 600 via the first sensor 501 to the third sensor 503. With such a configuration, the CPU 601 can detect a conductive state or a cutoff state of the transistor 617d.

A connector 610e of the fifth sensor 505 is not only connected to the fourth sensor 504 on the upstream side through the power supply line, but also connected to the sixth sensor 506 provided on the downstream side through another power supply line. To the connector 610e, such a signal line as described in the first embodiment is not connected. The fifth sensor 505 includes a voltage detection unit 611e, a power cutoff unit 612e, an LED 613e, a phototransistor 614e, an LED controller 615e, a sensor latch unit 616e, and a pull-up resistor 619e. Operations of the respective components are the same as the operations of the respective corresponding components of the first sensor 501, and hence descriptions thereof are omitted.

A collector terminal of a transistor 617e in the sensor latch unit 616e is connected to the power supply line of the fifth sensor 505 at a contact “e” via a resistor 618b. The contact “e” is connected to the A/D port of the CPU 601 of the main board 600 via the first sensor 501 to the fourth sensor 504. With such a configuration, the CPU 601 can detect a conductive state or a cutoff state of the transistor 617e.

A connector 610f of the sixth sensor 506 is connected to the fifth sensor 505 on the upstream side through the power supply line. The sixth sensor 506 is arranged on the most downstream side of series connection, and hence the connector 610f is not connected to any component in the subsequent stage. To the connector 610f, such a signal line as described in the first embodiment is not connected. The sixth sensor 506 includes a voltage detection unit 611f, a power cutoff unit 612f, an LED 613f, a phototransistor 614f, an LED controller 615f, a sensor latch unit 616f, and a pull-up resistor 619f. Operations of the respective components are the same as the operations of the respective corresponding components of the first sensor 501, and hence descriptions thereof are omitted.

A collector terminal of a transistor 617f in the sensor latch unit 616f is connected to the power supply line of the sixth sensor 506 at a contact “f” via a resistor 618f. The contact “f” is connected to the A/D port of the CPU 601 of the main board 600 via the first sensor 501 to the fifth sensor 505. With such a configuration, the CPU 601 can detect a conductive state or a cutoff state of the transistor 617f.

The power supply line can be connected in this manner, to thereby suppress the number of power supply lines for connecting the main board 600 and the plurality of sensors (first sensor 501 to sixth sensor 506). In addition, the power supply line is used both for supplying the power supply voltage and for acquiring the detection result, and hence series wires for connecting the main board 600 and the respective sensors (first sensor 501 to sixth sensor 506) can be reduced to two lines including a ground line.

### Operation Control of Sensors

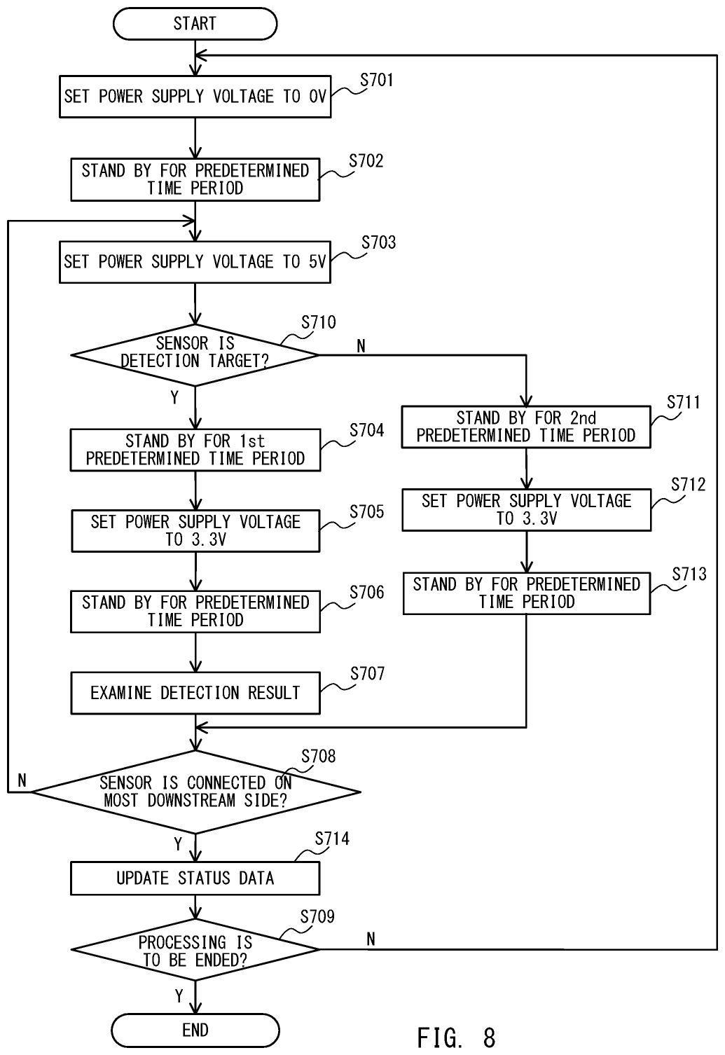

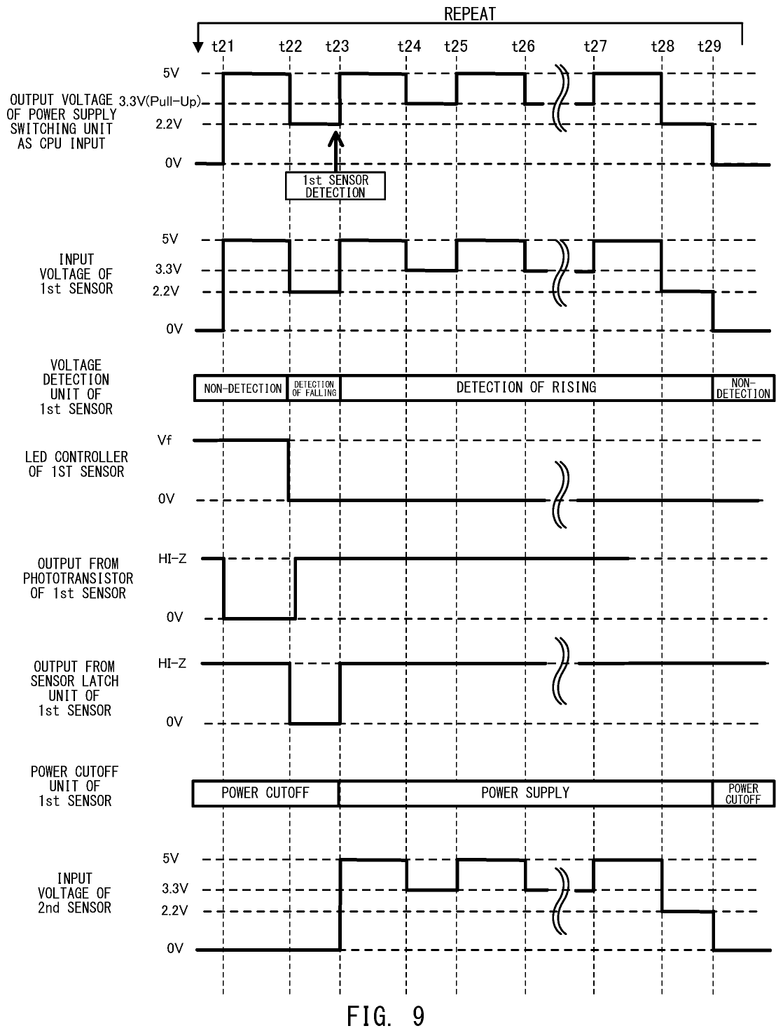

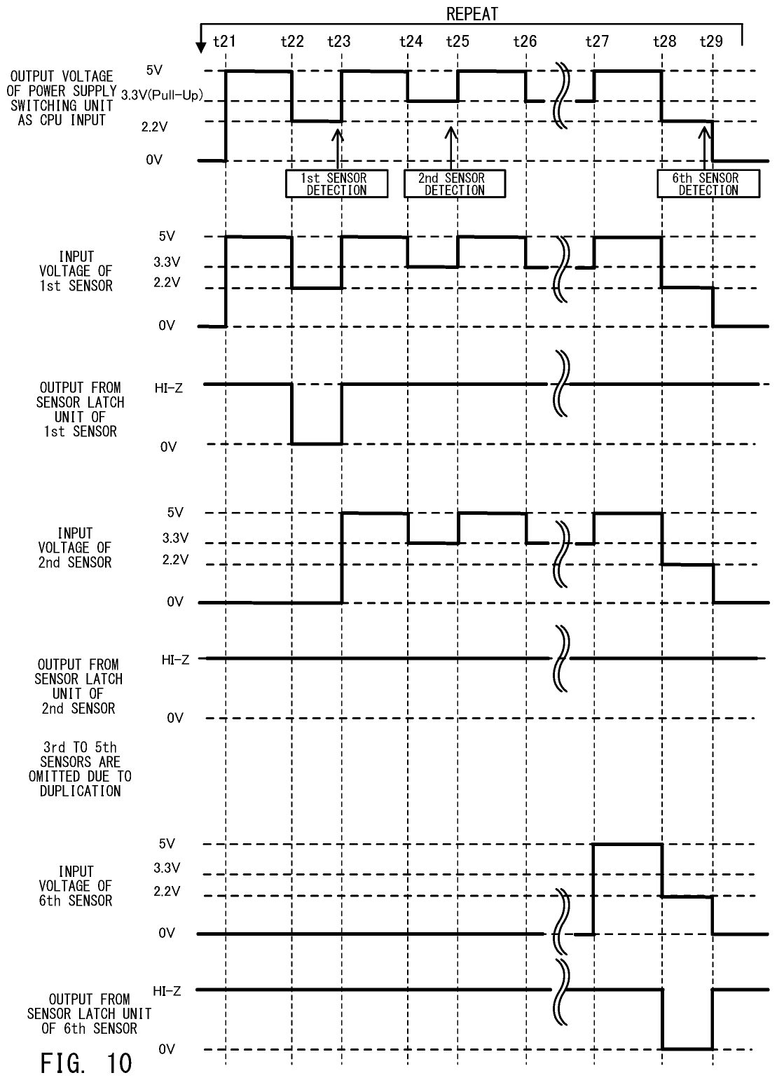

FIG. 8 is a flow chart for illustrating operation control processing for a sensor, which is performed by the main board 600. FIG. 9 is a timing chart exhibited when operations of the main board 600 and the first sensor 501 are controlled. FIG. 10 is a timing chart exhibited when operations of all the sensors are controlled.

The processing from Step S701 to Step S703 and the processing of Step S710 are the same as the processing from Step S301 to Step S303 and the processing of Step S310 in FIG. 3. Through the processing of Step S710, the CPU 601 performs processing corresponding to the determination result indicating whether or not the sensor being currently operated is a sensor from which a detection result is to be acquired.

When the sensor being currently operated is a sensor from which a detection result is to be acquired (Y in Step S710), the CPU 601 stands by for a first predetermined time period (for example, 100 microseconds) while maintaining the power supply voltage at 5 V (Step S704). The first predetermined time period is set to a time period during which the LED 613a emits light and the light receiving operation is reliably performed by the phototransistor 614a.

After a lapse of the first predetermined time period, the CPU 601 causes the power supply switching unit 602 to set the power supply voltage to 3.3 V pulled up by the pull-up resistor 606 (Step S705). With this setting, the voltage detection unit 611a detects the falling of the power supply voltage to be brought into the second state. When the voltage detection unit 611a is brought into the second state, the sensor latch unit 616a latches the state of the phototransistor 614a to switch the operation state of the transistor 617a. The sensor latch unit 616a maintains the transistor 617a in the conductive state when the phototransistor 614a is in the conductive state, and maintains the transistor 617a in the cutoff state when the phototransistor 614a is in the cutoff state.

When the voltage detection unit 611a is brought into the second state, the LED controller 615a is brought into the cutoff state, and the LED 613a turns out the light. The LED 613a turns out the light, and hence the phototransistor 614a is brought into the cutoff state. At this time, when the LED 613a completes an operation for turning out the light early with respect to a latching operation performed by the sensor latch unit 616a, there is a fear that the state of the phototransistor 614a exhibited when the LED 613a emits light, which is originally to be acquired, may not be latched. Therefore, the voltage detection unit 611a delays the transmission of the control signal to the LED controller 615a as compared to the transmission of the switching signal to the sensor latch unit 616a. The processing from Step S703 to Step S705 is processing performed between a time t21 and a time t22 in FIG. 9 and FIG. 10.

The CPU 601 stands by for a predetermined time period (for example, 75 microseconds) while maintaining the power supply voltage at 3.3 V (Step S706). The predetermined time period is a time period longer than a time period for switching the states of the voltage detection unit 611a and the sensor latch unit 616a.

When the predetermined time period has elapsed with the power supply voltage being maintained at 3.3 V, the CPU 601 acquires the voltage value of the contact “a” in the first sensor 501 to examine the detection result of the first sensor 501 (Step S707). With the above-mentioned processing, the CPU 601 detects whether the transistor 617a is in an operation state or a non-operation state (open). The processing of Step S706 and Step S707 is processing performed between the time t22 and a time t23 in FIG. 9 and FIG. 10.

The power supply line for connecting the contact “a” in the first sensor 501 and the CPU 601 is also connected to the power supply line from the second sensor 502 to the sixth sensor 506. However, the power cutoff unit 612a of the first sensor 501 is in the cutoff state, and hence the power supply voltage is not supplied to the second sensor 502 to the sixth sensor 506. The voltage detection unit 611a and the LED controller 615a are also connected to the contact “a” in the first sensor 501, but an electric current consumed by voltage detection is small with no electric current flowing through the LED 613a, and thus current consumption is minute.

For this reason, at the time of the processing of Step S707, the state of the power supply line is dominated by the state of the transistor 617a. Therefore, the voltage value at the contact “a” (power supply line) connected to the A/D port of the CPU 601 is substantially determined based on the conductive state and the cutoff state of the transistor 617a.

When the transistor 617a is in the conductive state, the voltage value to be acquired by the CPU 601 is determined based on a voltage dividing ratio between the pull-up resistor 606 and the resistor 618a. Assuming that the pull-up resistor 606 has a resistance value of 1.1 kΩ and the resistor 618a has a resistance value of 2.2 kΩ, the CPU 601 detects about 2.2 V (first sensor 501 detection in FIG. 9 and FIG. 10). When the transistor 617a is in the cutoff state, no electric current flows through the transistor 617a as well, and almost no electric current flows through the power supply line. Therefore, the CPU 601 detects about 3.3 V.

The CPU 601 compares an A/D conversion result of the voltage value acquired at the A/D port with a predetermined threshold value to determine whether or not the transistor 617a is in the conductive state. For example, the threshold value is set to 2.75 V. When the A/D conversion result is lower than 2.75 V, the CPU 601 determines that the transistor 617a is in the conductive state, and that the first sensor 501 has not detected the sheet 110. When the A/D conversion result is equal to or higher than 2.75 V, the CPU 601 determines that the transistor 617a is in the cutoff state, and that the first sensor 501 has detected the sheet 110.

In FIG. 9, waveforms exhibited when the light emitted from the LED 613a is received by the phototransistor 614a are illustrated for the sake of description. A shielding object is not provided between the LED 613a and the phototransistor 614a, and hence the phototransistor 614a receives light to be brought into the conductive state, which also brings the transistor 617a in the sensor latch unit 616a into the conductive state. In this case, the voltage value acquired by the CPU 601 is 2.2 V. When a shielding object is provided between the LED 613a and the phototransistor 614a, the phototransistor 614a does not receive light, and is brought into the cutoff state (high impedance), while the transistor 617a in the sensor latch unit 616a is also brought into the cutoff state (high impedance). In this case, the voltage value acquired by the CPU 601 is 3.3 V.

The CPU 601, which has acquired the detection result of the sensor, determines whether or not the sensor is connected on the most downstream side (Step S708). The determination method is the same as the processing of Step S306 in FIG. 3. In this case, the CPU 601 has acquired the detection result of the first sensor 501. Therefore, the CPU 601 determines that the sensor from which the detection result has been acquired is not connected on the most downstream side (N in Step S708), and again repeats the processing of Step S703 and the subsequent steps.

The CPU 601 sets the power supply voltage output by the power supply switching unit 602 to 5 V (Step S703). At this time, the voltage detection unit 611a of the first sensor 501 is changed to the third state. For that reason, the sensor latch unit 616a brings the transistor 617a into the cutoff state. The power cutoff unit 612a is brought into the conductive state, and the power supply voltage is supplied to the second sensor 502 on the downstream side. In the same manner as in the case of the first sensor 501, the CPU 601 acquires the detection result of the second sensor 502 (Step S704, Step S705, Step S706, and Step S707). In the processing of Step S707, the transistor 617a of the first sensor 501 is in the cutoff state, and the third sensor 503 to the sixth sensor 506 are not operating. Therefore, the input signal supplied to the A/D port of the CPU 601 changes based only on the state of the transistor 617b of the second sensor 502. The processing from Step S703 to Step S707 is processing performed between the time t23 and a time t25 in FIG. 9 and FIG. 10. In FIG. 10, a shielding object is provided between the LED 613b and the phototransistor 614b of the second sensor 502, and the phototransistor 614b does not receive light to be brought into the cutoff state (high impedance). In this case, the voltage value acquired by the CPU 601 is 3.3 V.

The second sensor 502 is not connected on the most downstream side (N in Step S708), and hence the CPU 601, which has acquired the detection result of the second sensor 502, again repeats the processing of Step S703 and the subsequent steps. The CPU 601 sets the power supply voltage output by the power supply switching unit 602 to 5 V (Step S703). In the same manner as in the case of the second sensor 502, the CPU 601 acquires the detection result of the third sensor 503 (Step S704, Step S705, Step S706, and Step S707). In the processing of Step S707, the transistor 617a of the first sensor 501 and the transistor 617b of the second sensor 502 are in the cutoff state. Therefore, the input signal supplied to the A/D port of the CPU 601 changes based only on the state of the transistor 617c of the third sensor 503. The CPU 601 acquires the detection results of the fourth sensor 504 to the sixth sensor 506 in the same manner.

In FIG. 9 and FIG. 10, the phototransistor 614f of the sixth sensor 506 receives light to be brought into a conductive state, and the transistor 617f in the sensor latch unit 616f is also brought into a conductive state. In this case, the voltage value acquired by the CPU 601 is 2.2 V.

The CPU 601, which has acquired the detection result of the sixth sensor 506, determines whether or not the sixth sensor 506 is connected on the most downstream side (Step S708). The CPU 601 has acquired the detection result of the sixth sensor 506, and hence determines that the sensor from which the detection result has been acquired is connected on the most downstream side (Y in Step S708). The CPU 601, which has acquired the detection result of the sensor on the most downstream side, updates the status data (Step S714). When the detection operation is to be brought to an end (Y in Step S709), the CPU 601 brings the processing to an end.

When the detection operation is to be continued (N in Step S709), the CPU 601 returns to the processing of Step S701 to set the power supply voltage output by the power supply switching unit 602 to 0 V, and stands by for a predetermined time period. With this processing, the respective states of the voltage detection units 611a to 611f of the first sensor 501 to the sixth sensor 506, which are connected in series, are initialized to be brought into the first state. The power cutoff units 612a to 612f are brought into the cutoff state being the initial state, to thereby cut off the power supply voltage supplied to the sensor on the downstream side. After that, the CPU 601 repeatedly performs the processing from Step S703 to Step S709, to thereby be able to detect the states of the first sensor 501 to the sixth sensor 506 at all times. In this manner, the first sensor 501 to the sixth sensor 506 perform the detection operation in order.

When the sensor being currently operated is not a sensor from which a detection result is to be acquired (N in Step S710), the CPU 601 stands by for the second predetermined time period (for example, 10 microseconds) while maintaining the power supply voltage at 5 V (Step S711). The second predetermined time period is set to a required time period long enough for the voltage detection units 611a, 611b, 611c, 611d, 611e, and 611f to detect that the power supply voltage has been changed to 5 V. As described in the first embodiment, the sensor having the detection operation to be skipped does not have any problem in terms of operation even when the time period during which the power supply voltage is maintained at 5 V is shortened. Through shortening of this time period, it is possible to shorten the time period for switching the power supply destination to the sensor on the subsequent stage.

After a lapse of the second predetermined time period, the CPU 601 causes the power supply switching unit 602 to set the power supply voltage to 3.3 V pulled up by the pull-up resistor 606 (Step S712). This processing is the same processing as the processing of Step S705. The CPU 601 stands by for a predetermined time period (for example, 75 microseconds) while maintaining the power supply voltage at 3.3 V (Step S713). This processing is the same processing as the processing of Step S706. After standing by for the predetermined time period, the CPU 601 performs the processing of Step S708 and the subsequent steps. In this manner, when the second predetermined time period has elapsed, the CPU 601 performs the processing of Step S708 without examining the detection result of the sensor.

With the above-mentioned processing, the first sensor 501 to the sixth sensor 506 perform the same operation on the input signal (power supply voltage). However, through shifting of the timing to supply power to the respective sensors, the CPU 601 can independently detect the states of all the sensors.

Each sensor can use the same interface for connection to the main board 600 or another sensor irrespective of the connection point (most upstream, most downstream, or halfway) in the series connection. Therefore, sensors of the same kind (of the same outer shape and having the same internal circuit) can be used as all the sensors. The main board 600 is not required to manage the correspondence between the connection point and the sensor. The sensors are not required to have outer shapes individually changed, and each have an inexpensive configuration that does not require a complicated control circuit for, e.g., packet communication. The number of sensors connected in series to the main board 600 is six, but it is also possible to further increase the number of sensors under the same control.

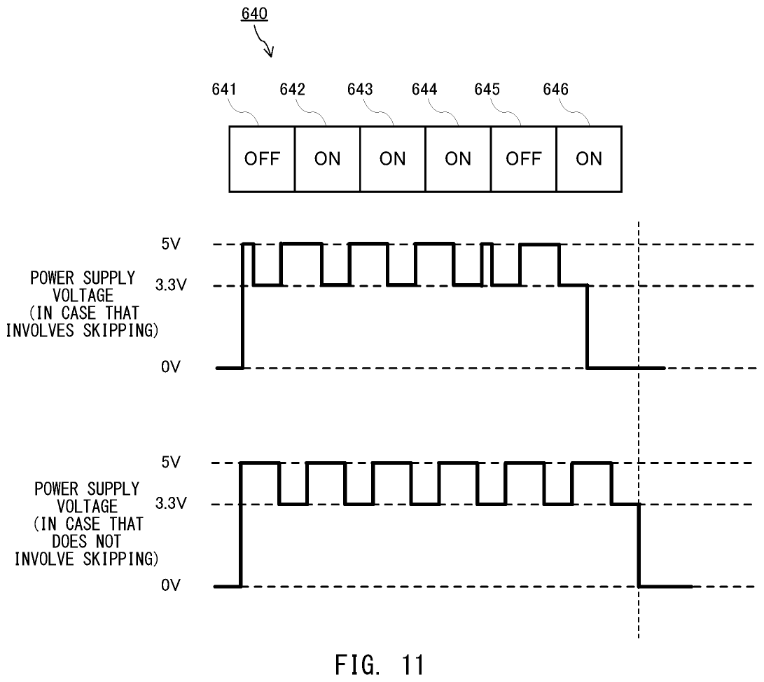

FIG. 11 is an explanatory diagram of a power supply voltage exhibited when the detection processing is to be skipped. In FIG. 11, status data 640 for indicating a target from which a detection result is to be acquired and power supply voltages output from the power supply switching unit 602 are illustrated. The status data 640 is stored in the CPU 601, and includes status information pieces 641 to 646 each indicating whether or not each corresponding one of the first sensor 501 to the sixth sensor 506, respectively, is the target from which a detection result is to be acquired.

The CPU 601 controls a time period for outputting the power supply voltage from the power supply switching unit 602 based on the status information pieces 641 to 646. In the status data 640, “ON” indicates that the sensor is the target from which a detection result is to be acquired, while “OFF” indicates that the sensor is not the target. In the case of FIG. 11, the status data 640 is set so as to skip two sensors (first sensor 501 and fifth sensor 505). In other words, the status information pieces 641 and 645 are set to “OFF”. In the processing of Step S710, the CPU 601 uses the sensor being currently operated and the status data 640 to determine whether or not the sensor is the target from which a detection result is to be acquired.

In the status data 640 at this time, the detection operations of two sensors are omitted, and hence a total time period to be taken until one round of the detection operations performed by all the sensors is finished can be made shorter than in a case that does not involve the skipping. In the example of FIG. 11, a time period for applying the power supply voltage of 5 V to the first sensor 501 and the fifth sensor 505 becomes shorter in a case that involves the skipping than in the case that does not involve the skipping. The total time period required for the detection operations performed by all the sensors becomes shorter by the shortened amount of time.

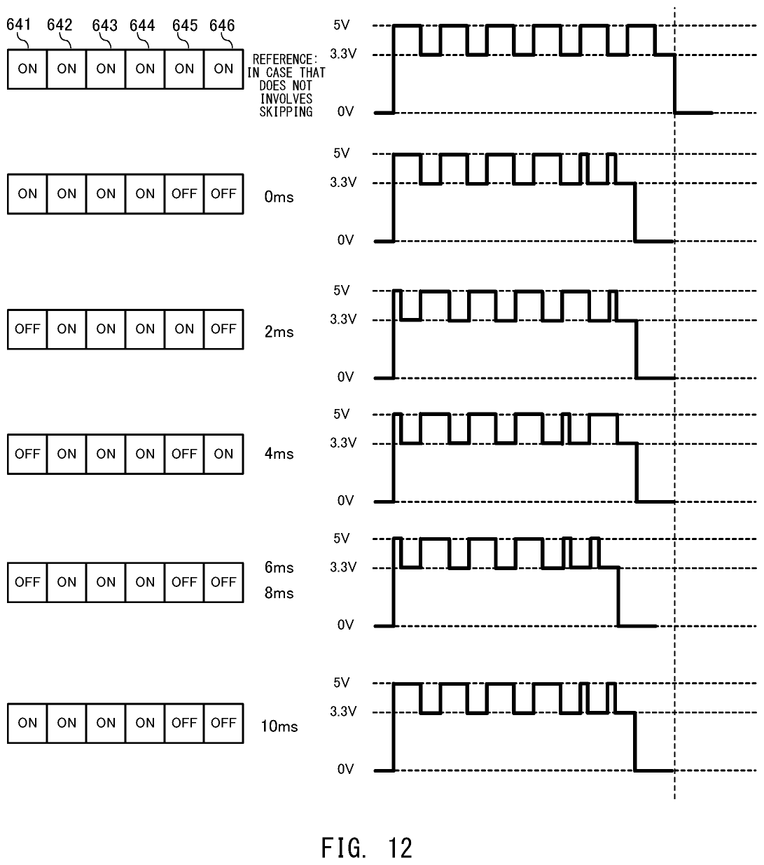

FIG. 12 is an explanatory diagram of a power supply voltage exhibited when there coexist sensors having different detection cycle periods. The sensors having a relatively short detection cycle period are not skipped, while the sensors having a relatively long detection cycle period are skipped. The sensors having a relatively short detection cycle period are the second sensor 502 to the fourth sensor 504 that are provided on the conveyance path of the sheet 110. The detection cycle period of each of the second sensor 502 to the fourth sensor 504 is, for example, 2 milliseconds. The sensors having a relatively long detection cycle period are the first sensor 501, the fifth sensor 505, and the sixth sensor 506 that are provided at positions at each of which the sheet 110 is received or placed. The detection cycle period of each of the first sensor 501, the fifth sensor 505, and the sixth sensor 506 is, for example, 10 milliseconds. It suffices that the first sensor 501, the fifth sensor 505, and the sixth sensor 506 each perform the detection operation at least one time during a period of 10 milliseconds, and those sensors may be skipped in the other rounds.

When any one of the first sensor 501, the fifth sensor 505, and the sixth sensor 506 is operated, the operations of the other two are skipped. Therefore, the operations of two sensors can be skipped in one round for operating all the sensors, which shortens a detection time period of one round for operating all the sensors. In order to switch the sensor to be skipped, the CPU 601 updates the status data 640 in the processing of Step S714. Through shortening of the detection time period, it is possible to increase the number of sensors that can perform the detection operation with the same detection time period of one round. In the second embodiment, the detection cycle periods are a combination of 2 milliseconds and 10 milliseconds, but the present disclosure is not limited thereto, and the detection time period can be shortened by similar processing.

A plurality of sensors of the same kind (of the same outer shape and having the same internal circuit) are connected in series. The respective sensors can independently perform the detection operations. Therefore, it is possible to reduce the number of cables and the number of connectors, and suppress costs including a component management cost. It is also possible to cut the costs by reducing the number of pins of the connector 603 of the main board 600 and an occupied area thereof. In the case where the detection result of a specific one of a pair of sensors is required while the detection result of the other one of the pair of sensors is not required or in other such cases of functionally exclusive sensors, it is also possible to shorten the detection time period per round by constantly skipping any one of the pair.

As described above, according to the first and second embodiments, it is possible to operate each sensor with its unique detection cycle period even with a configuration in which a plurality of sensors of the same kind are connected in series.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-126365, filed Jul. 2, 2018 which is hereby incorporated by reference herein in its entirety.

What is claimed is:

1. A sensor device, comprising:
a plurality of sensors connected in series, wherein the plurality of sensors include a first sensor and a second sensor connected to the first sensor, and wherein each of the plurality of sensors includes:
a first switch provided to a first power supply line for receiving a voltage;
a second switch provided to a second power supply line for supplying the voltage to another sensor that is subsequently connected among the plurality of sensors; and
a contact provided between the first power supply line and the second power supply line, wherein the contact is positioned at an upstream side of the first switch;
a voltage supply circuit configured to supply the voltage, wherein the voltage supply circuit is connected to the first sensor among the plurality of sensors; and
wherein a state of the first switch becomes a conductive state in a case where a first voltage is received when states of the first switch and the second switch are a cutoff state;
wherein the state of the first switch becomes the cutoff state in a case where a second voltage different from the first voltage is received when (i) the state of the first switch is the conductive state and (ii) the state of the second switch is the cutoff state;
wherein the state of the second switch becomes a conductive state in a case where the second voltage is received when the states of the first switch and the second switch are the cutoff state;
wherein the states of the first switch and the second switch become the cutoff state in a case where the voltage supply circuit is controlled to a predetermined condition;
wherein the voltage supply circuit executes first processing in which the first voltage is supplied during a first time period, and second processing in which the first voltage is supplied during a second time period, which is shorter than the first time period.

2. The sensor device according to claim 1, wherein the voltage supply circuit cuts off the voltage in the predetermined condition.

3. The sensor device according to claim 1, wherein the voltage supply circuit supplies an initial voltage different from each of the first voltage and the second voltage in the predetermined condition.

4. The sensor device according to claim 1, wherein, in a case of repeatedly acquiring detection results of the plurality of sensors, the voltage supply circuit is controlled to the predetermined condition again each time when a detection operation is executed by a sensor connected on a most downstream side among the plurality of sensors.

5. The sensor device according to claim 1,
wherein each of the plurality of sensors includes:
a light emitting element; and
a light receiving element, and
wherein the voltage is supplied to the light emitting element through the first power supply line when the first switch is in the conductive state.

6. The image forming apparatus according to claim 1, wherein the second voltage is lower than the first voltage.

7. An image forming apparatus, comprising:
a conveyance unit configured to convey a sheet along a conveyance path;
a plurality of sensors each configured to detect the sheet, wherein the plurality of sensors are connected in series, wherein the plurality of sensors include a first sensor and a second sensor connected to the first sensor, and wherein each of the plurality of sensors includes:
a first switch provided to a first power supply line for supplying a voltage; and
a second switch provided to a second power supply line for supplying the voltage to another sensor that is subsequently connected among the plurality of sensors, and
a contact provided between the first power supply line and the second power supply line, wherein the contact is positioned at an upstream side of the first switch;
a voltage supply circuit configured to supply the voltage, wherein the voltage supply circuit is connected to the first sensor among the plurality of sensors; and
a controller configured to:
control the voltage supply circuit to supply a first voltage, wherein a state of the first switch becomes a conductive state in a case where the first voltage is received when states of the first switch and the second switch are a cutoff state;
control the voltage supply circuit to supply a second voltage different from the first voltage, wherein the state of the first switch becomes the cutoff state in a case where the second voltage is received when (i) the state of the first switch is the conductive state and (ii) the state of the second switch is the cutoff state, wherein the state of the second switch becomes a conductive state in a case where the second voltage is received when the states of the first switch and the second switch are the cutoff state;
control the voltage supply circuit to a predetermined condition, wherein the states of the first switch and the second switch become the cutoff state in a case where the voltage supply circuit is controlled to the predetermined condition;
wherein the controller executes first processing for causing the voltage supply circuit to supply the first voltage during a first time period, and second processing for causing the voltage supply circuit to supply the first voltage during a second time period, which is shorter than the first time period.

8. The image forming apparatus according to claim 7, wherein the controller controls the voltage supply circuit to cut off the voltage in the predetermined condition.

9. The image forming apparatus according to claim 7, wherein the controller controls the voltage supply circuit to supply an initial voltage different from each of the first voltage and the second voltage in the predetermined condition.

10. The image forming apparatus according to claim 7,
wherein the controller executes, in a case where the conveyance unit is to be controlled based on a detection result of the first sensor, the first processing in a time when the first sensor is driven, and
wherein the controller executes, in a case where the conveyance unit is not to be controlled based on the detection result of the first sensor, the second processing in a time when first sensor is driven.

11. The image forming apparatus according to claim 7,
wherein the controller executes, in a case where the conveyance unit is to be controlled based on a detection result of the second sensor, the first processing in a time when the second sensor is driven, and
wherein the controller executes, in a case where the conveyance unit is not to be controlled based on the detection result of the second sensor, the second processing in a time when the second sensor is driven.

12. The image forming apparatus according to claim 7, wherein the second voltage is lower than the first voltage.
